(19) United States
(12) Patent Application Publication
(10) Pub. No.: US 2013/0293376 A1
(43) Pub. Date: Nov. 7, 2013

(54) METHODS AND SYSTEMS FOR RECOVERING VICTIMS AFTER A DISASTER

(71) Applicant: Tai Cheung Poon, Wanchai (HK)

(72) Inventor: Tai Cheung Poon, Wanchai (HK)

(21) Appl. No.: 13/465,088

(22) Filed: May 7, 2012

(51) Int. Cl. G08B 1/08

(52) U.S. Cl. 340/539.12

(57) ABSTRACT

A system and method are provided for locating and recovering victims during a disaster or crisis. The system generally employs a watch worn by a potential victim that is able to detect heart rate and location. Upon occurrence of a disaster, the watch may be triggered to automatically transmit location and vital information regarding the potential victim wearing the watch. If unable to transmit the aforementioned data, the signal-transmitting portion of the watch may become automatically detached from the victim. At which time a movement mechanism contained within the signal transmitter causes it to move physically to a location with better network and GPS satellite reception. Once able to connect to a network or satellite, the signal transmitter sends the location and vital data for remote access in order to facilitate an informed and efficient rescue of the victim.

### FIELD OF THE INVENTION

This invention is generally related to disaster and emergency recovery. More specifically, this invention is related to a system and method for electronically tracking victims during a disaster.

### BACKGROUND OF THE INVENTION

Earthquakes have become increasingly prevalent over the past decade. Recently, an earthquake in Japan caused shut down of a series of nuclear power plants. During the incident, power plants were damaged following the 7.1 magnitude earthquake that struck northern Japan. That earthquake was one of the largest in history, causing disruption of Japan's economies, and more importantly, affecting a large amount of lives in the country. During a tsunami in 2004, thousands of people were killed and many are missing after a tsunami triggered by an earthquake off the coast of Sumatra, Indonesia struck.

Recently, it has been admitted that the number of deaths could have been drastically reduced if proper measures were taken. Such proper measures could include, for example, mechanisms that can detect health conditions of the victims, such as the pulse reading. Easily detectable, the pulse rate would be able to indicate which victims will require immediate medical attention. Furthermore, other measures such as reporting the current location of the victims could help save many lives. This may present additional challenges to the rescue team, as most victims during an earth quake, are fully covered by debris, causing more obstacles for the location detection devices to detect location signals. As such, there is a demand for rescuing devices which are able to pinpoint locations of victims, regardless of the presence of a network signal at the location of the victim.

As a result, in view of the foregoing, there is a need unfulfilled in the art for a rescue and recovery system that locates and reports vital information of victims present at sites most susceptible to environmental disasters.

### SUMMARY OF THE INVENTION

According to embodiments of the invention, communication system for discovering victims in a disaster is provided. The system employs a number of components. Firstly, a watch is provided worn on a wrist of a potential disaster victim. A pulse detector is contained inside the watch to monitor pulse of the potential victim. A signal transmitter is releasably affixed to the watch. The signal transmitter contains a GPS receiver and is operable to report signals regarding the pulse of the potential victim and GPS coordinates read by the GPS receiver. Furthermore, the signal transmitter configured to detach from the watch upon failure of the GPS receiver to obtain a connection to a GPS satellite.

A mechanical leg is attached to the signal transmitter. The leg is operable to physically move the signal transmitter to an open location in order to report signals. The signals including the location and the pulse of the potential victim. The GPS receiver is configured to calculate distance and direction signal transmitter has travelled since detachment from the potential victim in order to accurately report an exact location of the potential victim. A processor and a memory are also provided.

The memory contains instructions that cause the processor to execute a method when prompted. The method comprises the following steps. The first step being the measuring of the pulse of the potential victim using the pulse detector. The second step entailing detecting the current location of the potential victim using the GPS receiver. Next, the data is reported regarding pulse and location via a network node.

The method may further comprise a number of additional steps if the GPS is unable to detect the current location. The first involving the signal transmitter becoming detached from the watch. The mechanical leg of the signal transmitter then causes the signal transmitter to move in the direction of higher elevation. Movement is adjusted if the signal transmitter encounters an impassible obstacle. From the time of becoming detached, the signal transmitter records distance and direction travelled from the potential victim. Thus, the original location of the victim can still be determined once the signal transmitter is able to connect to a network. Next, the location data is sent upon reaching a point at which GPS satellites are accessible.

Alternatively, the method may comprise the following additional steps if a network node is inaccessible from the current location of the signal transmitter. The first involving the signal transmitter becoming detached from the watch. The mechanical leg of the signal transmitter then causes the signal transmitter to move in the direction of higher elevation. Movement is adjusted if the signal transmitter encounters an impassible obstacle. From the time of becoming detached, the signal transmitter records distance and direction travelled from the potential victim. Thus, the original location of the victim can still be determined once the signal transmitter is able to connect to a network. Next, pulse and location data are sent upon reaching a point at which a network node is accessible.

In further embodiments of the disclosed system, the data reported further comprises the duration of time during which the potential victim has been stationary. The data may also include the location of the potential victim as calculated by the recorded distance and direction traversed by the detached signal transmitter. The signal transmitter may be waterproof and shockproof in order to ensure that it can withstand a potential disaster such as a tsunami or earthquake.

In another embodiment of the disclosed technology, a method for locating victims during a crisis is provided. The first step involves providing a watch to be worn by a potential victim. The watch comprises a detachable signal transmitter with a GPS receiver and extendable mechanical leg disposed therein. The signal transmitter is operable to measure the pulse of the potential victim. The second step entails detecting a location of the potential victim upon occurrence of a crisis. The pulse of the potential victim is measured upon occurrence of the crisis. The method proceeds with the signal transmitter reporting data regarding the location and the pulse of the victim using signals. If unable to report data, the signal transmitter becomes detached from the watch.

Once detached, the next step involves moving the signal transmitter, using the leg, in a direction of higher elevation, and adjusting movement based on an encounter of an impassible obstacle. While moving, the signal transmitter is recording distance and direction traversed from the potential victim. Then, upon reaching a point at which GPS satellites are accessible location data is recorded and sent. Finally, the method ends with the step of sending data upon reaching a point at which a network node is accessible. The data being sent comprises the potential victims pulse. Additionally, the location of the victim may also be sent. The location may be calculated by the recorded distance and direction traversed by the detached signal transmitter. The data sent may also comprise the duration of time during which the potential victim is stationary. Thus signifying whether the victim is conscious or capable of movement.

In accordance with these and other objects which will become apparent hereinafter, the invention will now be described with particular reference to the drawing.

### BRIEF DESCRIPTION OF THE DRAWINGS

FIG. 1 shows a diagram of an overview of a victim recovery system according to embodiments of the disclosed invention.

FIG. 2 shows a flow chart of a method of locating victims during a crisis according to embodiments of the disclosed invention.

### DETAILED DESCRIPTION

According to embodiments of the invention, a system and method are provided for locating and recovering victims during a disaster or crisis. The system generally employs a watch worn by a potential victim that is able to detect heart rate and location. Upon occurrence of a disaster, the watch may be triggered to automatically transmit location and vital information regarding the potential victim wearing the watch. If unable to transmit the aforementioned data, the signal-transmitting portion of the watch may become automatically detached from the victim. At which time a movement mechanism contained within the signal transmitter causes it to move physically to a location with better network and GPS satellite reception. Once able to connect to a network or satellite, the signal transmitter sends the location and vital data for remote access in order to facilitate an informed and efficient rescue of the victim.

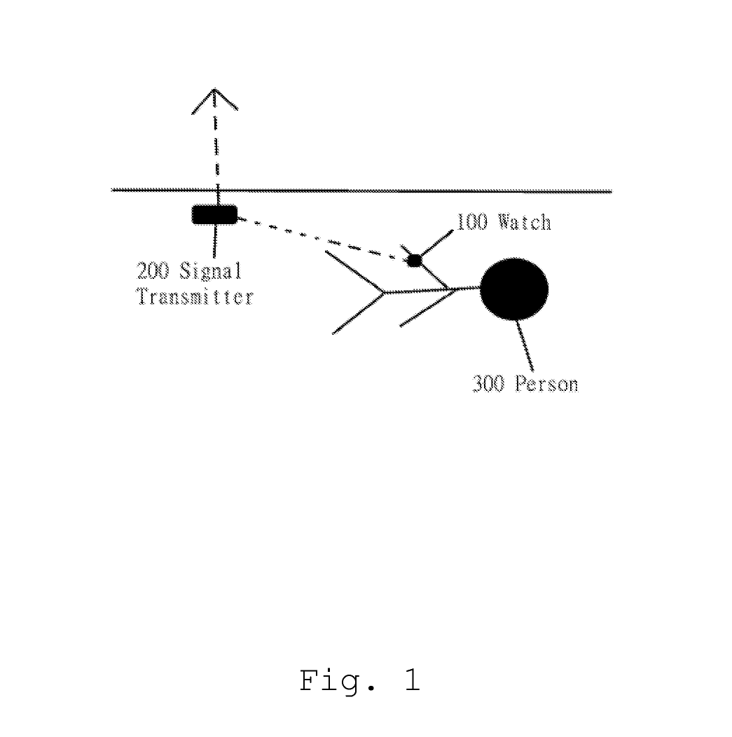

Referring now to the drawings, FIG. 1 shows a diagram of an overview of a victim recovery system according to embodiments of the disclosed invention. This figure gives a general overview of how the disclosed system and method work. A watch 100 is shown affixed to the wrist of a victim or person 300. It is envisioned that the person 300 is injured, unconscious, or otherwise unable to move. Moreover, the person 300 may be trapped under debris or in a building. Thus, as pictured, a signal transmitter 200 has become detached from the watch 100 and has travelled the path of the dotted line. The signal transmitter 200 having done so because it was unable to obtain satellite or network reception at the particular location of the victim 300. A mechanical leg is shown extending from the signal transmitter 200. The leg operable to move the signal transmitter 200 to a location of higher elevation. Upon reaching a location with connectivity, the signal transmitter 200 transmits or broadcasts important information regarding the person 300.

According to embodiments of the invention, communication system for discovering victims in a disaster is provided. The system employs a number of components. Firstly, a watch is provided worn on a wrist of a potential disaster victim. A pulse detector is contained inside the watch to monitor pulse of the potential victim. A signal transmitter is releasably affixed to the watch. The signal transmitter contains a GPS receiver and is operable to report signals regarding the pulse of the potential victim and GPS coordinates read by the GPS receiver. Furthermore, the signal transmitter configured to detach from the watch upon failure of the GPS receiver to obtain a connection to a GPS satellite.

A mechanical leg is attached to the signal transmitter. The leg is operable to physically move the signal transmitter to an open location in order to report signals. The signals including the location and the pulse of the potential victim. The GPS receiver is configured to calculate distance and direction signal transmitter has travelled since detachment from the potential victim in order to accurately report an exact location of the potential victim. A processor and a memory are also provided.

The memory contains instructions that cause the processor to execute a method when prompted. The method comprises the following steps. The first step being the measuring of the pulse of the potential victim using the pulse detector. The second step entailing detecting the current location of the potential victim using the GPS receiver. Next, the data is reported regarding pulse and location via a network node.

The method may further comprise a number of additional steps if the GPS is unable to detect the current location. The first involving the signal transmitter becoming detached from the watch. The mechanical leg of the signal transmitter then causes the signal transmitter to move in the direction of higher elevation. Movement is adjusted if the signal transmitter encounters an impassible obstacle. From the time of becoming detached, the signal transmitter records distance and direction travelled from the potential victim. Thus, the original location of the victim can still be determined once the signal transmitter is able to connect to a network. Next, the location data is sent upon reaching a point at which GPS satellites are accessible.

Alternatively, the method may comprise the following additional steps if a network node is inaccessible from the current location of the signal transmitter. The first involving the signal transmitter becoming detached from the watch. The mechanical leg of the signal transmitter then causes the signal transmitter to move in the direction of higher elevation. Movement is adjusted if the signal transmitter encounters an impassible obstacle. From the time of becoming detached, the signal transmitter records distance and direction travelled from the potential victim. Thus, the original location of the victim can still be determined once the signal transmitter is able to connect to a network. Next, pulse and location data are sent upon reaching a point at which a network node is accessible.

In further embodiments of the disclosed system, the data reported further comprises the duration of time during which the potential victim has been stationary. The data may also include the location of the potential victim as calculated by the recorded distance and direction traversed by the detached signal transmitter. The signal transmitter may be waterproof and shockproof in order to ensure that it can withstand a potential disaster such as a tsunami or earthquake.

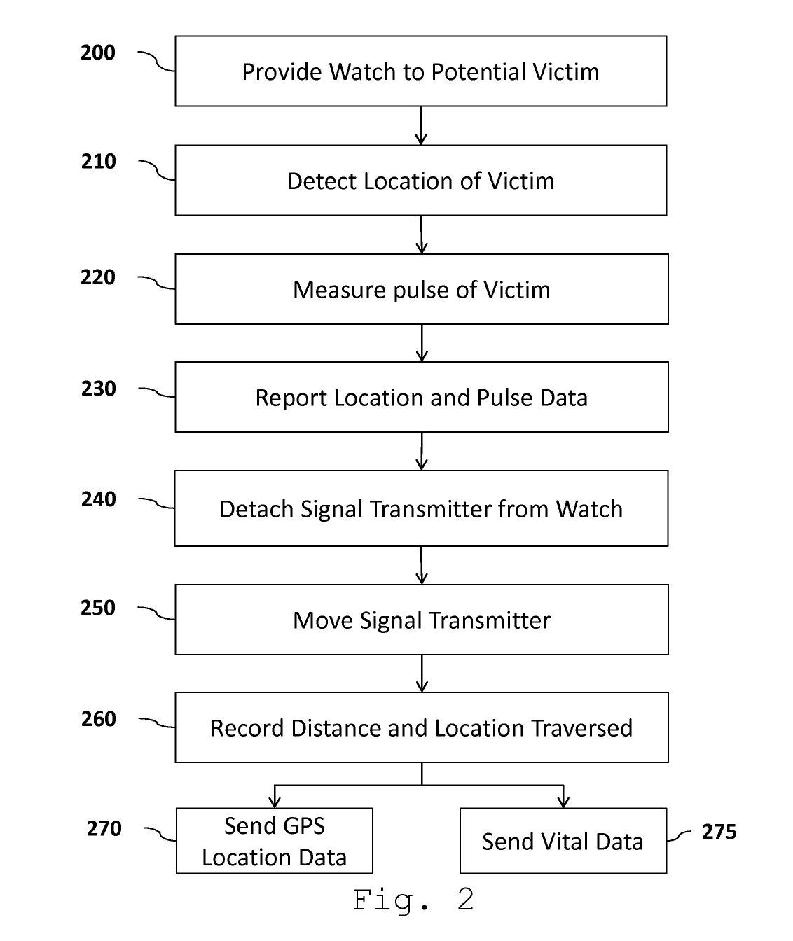

FIG. 2 shows a flow chart of a method of locating victims during a crisis according to embodiments of the disclosed invention. The memory contains instructions that cause the processor to execute a method when prompted. The steps of the method are stored in the memory and executed by the processor. The first step 200 involves providing a watch to be worn by a potential victim. The watch comprises a detachable signal transmitter with a GPS receiver and extendable mechanical leg disposed therein. The signal transmitter is operable to measure the pulse of the potential victim. The second step 210 entails detecting a location of the potential victim upon occurrence of a crisis. In step 220, the pulse of the potential victim is measured upon occurrence of the crisis. The method proceeds with the signal transmitter reporting data 230 regarding the location and the pulse of the victim using signals. If unable to report data, the signal transmitter becomes detached 240 from the watch.

Once detached, the next step 250 involves moving the signal transmitter, using the leg, in a direction of higher elevation, and adjusting movement based on an encounter of an impassible obstacle. While moving, the signal transmitter is recording 260 distance and direction traversed from the potential victim. Then in step 270, upon reaching a point at which GPS satellites are accessible location data is recorded and sent. Finally in step 275, the method ends with the step of sending data upon reaching a point at which a network node is accessible. The data being sent comprises the potential victims pulse. Additionally, the location of the victim may also be sent. The location may be calculated by the recorded distance and direction traversed by the detached signal transmitter. The data sent may also comprise the duration of time during which the potential victim is stationary. Thus signifying whether the victim is conscious or capable of movement.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A communication system for discovering victims in a disaster, comprising:
a watch worn on a wrist of a potential victim;
a pulse detector contained inside the watch to monitor pulse of the potential victim;
a signal transmitter detachably affixed to the watch, the signal transmitter comprising a GPS receiver;
the signal transmitter operable to report signals regarding the pulse of the potential victim and GPS coordinates read by the GPS receiver, the signal transmitter configured to detach from the watch upon failure of the GPS receiver to obtain a connection to a GPS satellite;
a mechanical leg attached to the signal transmitter, the leg operable to physically move the signal transmitter to an open location in order to report the signals including the location and the pulse of the potential victim;
the GPS receiver configured to calculate a distance and a direction that the signal transmitter has travelled since detachment from the potential victim in order to accurately report an exact location of the potential victim;
a processor; and
a memory comprising instructions that cause the processor to execute a method when prompted, the method comprising the following steps:
measuring the pulse of the potential victim using the pulse detector;
detecting a current location of the potential victim using the GPS receiver; and
reporting data regarding pulse and location via a network node.

2. The system of claim 1, wherein the method further comprises the following steps:
detaching the signal transmitter upon failure to detect the current location;
moving the signal transmitter, using the leg, in a direction of higher elevation;
adjusting movement based on an encounter of an impassable obstacle;
recording the distance and direction travelled from the potential victim; and
sending location data upon reaching a point at which GPS satellites are accessible.

3. The system of claim 1, wherein the method further comprises the following steps:
detaching the signal transmitter upon failure to report data;
moving the signal transmitter, using the leg, in a direction of higher elevation;
adjusting movement based on an encounter of an impassable obstacle;
recording distance and direction traversed from the potential victim; and
sending pulse and location data upon reaching a point at which a network node is accessible

4. The system of claim 1, wherein the data reported further comprises a duration of time during which the potential victim has been stationary.

5. The system of claim 2, wherein the data sent further comprises a location of the potential victim as calculated by the recorded distance and direction travelled by the detached signal transmitter.

6. The system of claim 3, wherein the data sent further comprises a location of the potential victim as calculated by the recorded distance and direction traversed by the detached signal transmitter.

7. The system of claim 1, wherein the signal transmitter is waterproof and shockproof.

8. The system of claim 2, wherein the signal transmitter is waterproof and shockproof.

9. The system of claim 3, wherein the signal transmitter is waterproof and shockproof.

10. A communication system for discovering victims in a disaster, comprising:
a watch worn on a wrist of a potential victim;
a pulse detector contained inside the watch to monitor a pulse of the potential victim;
a signal transmitter detachably affixed to the watch, the signal transmitter comprising a GPS receiver;
the signal transmitter operable to report signals regarding the pulse of the potential victim and GPS coordinates read by the GPS receiver, the signal transmitter configured to detach from the watch upon failure of the GPS receiver to obtain a connection to a GPS satellite;
a mechanical leg attached to the signal transmitter, the leg operable to physically move the signal transmitter to an open location in order to report the signals including the location and the pulse of the potential victim;
the GPS receiver configured to calculate and record a distance and a direction that the signal transmitter has travelled since detachment location of the potential victim;
a processor;
a memory comprising instructions that cause the processor to execute a method when prompted, the method comprising the following steps:
measuring the pulse of the potential victim using the pulse detector;
detecting current location of the potential victim using the GPS receiver;
reporting data regarding pulse and location via a network node;
detaching the signal transmitter upon failure to access a network node;
moving the signal transmitter, using the leg, in a direction of higher elevation;
adjusting movement based on an encounter of an impassable obstacle;
recording distance and direction traversed from the potential victim;
sending location data upon reaching a point at which GPS satellites are accessible; and
sending pulse data upon reaching a point at which a network node is accessible.

11. The system of claim 10, wherein the data sent further comprises a location of the potential victim as calculated by the recorded distance and direction traversed by the detached signal transmitter.

12. The system of claim 11, wherein the data reported further comprises a duration of time during which the potential victim has been stationary.

13. The system of claim 1, wherein the signal transmitter is waterproof and shockproof.

14. A method for locating victims during a crisis, the method comprising the following steps:
providing a watch to a be worn by a potential victim, the watch comprising a detachable signal transmitter with a GPS receiver and an extendable mechanical leg disposed therein, the signal transmitter operable to measure a pulse of the potential victim;
detecting a location of the potential victim upon occurrence of a crisis;
measuring a pulse of the potential victim upon occurrence of a crisis;
reporting data regarding the location and the pulse of the victim using signals transmitted by the signal transmitter;
detaching the signal transmitter from the watch upon failure to report data;
moving the signal transmitter, using the leg, in a direction of higher elevation;
adjusting movement based on an encounter of an impassable obstacle;
recording distance and direction traversed from the potential victim;
recording and sending location data upon reaching a point at which GPS satellites are accessible; and
sending data upon reaching a point at which a network node is accessible, the data comprising the potential victims pulse.

15. The method of claim 14, wherein the data sent further comprises a location of the potential victim as calculated by the recorded distance and direction traversed by the detached signal transmitter.

16. The method of claim 15, wherein the data sent further comprises the duration of time during which the potential victim has been stationary.
